(19) United States
(12) Patent Application Publication
(10) Pub. No.: US 2024/0128857 A1
(43) Pub. Date: Apr. 18, 2024

(54) METHOD FOR THE STARTING OF AN ELECTROLYSIS SYSTEM, AND ELECTROLYSIS SYSTEM FOR CARRYING OUT THE METHOD

(71) Applicants: SMA Solar Technology AG, Niestetal (DE); Sunfire GmbH, Dresden (DE)

(72) Inventors: Alexander Unru, Baunatal (DE); Eike Rafael Koch, Dresden (DE)

(21) Appl. No.: 18/396,810

(22) Filed: Dec. 27, 2023

Related U.S. Application Data
(63) Continuation of application No. PCT/EP2022/066781, filed on Jun. 21, 2022.

(30) Foreign Application Priority Data
Jul. 1, 2021 (EP) 21183299.3

(51) Int. Cl. H02M 1/36; C25B 1/04; C25B 9/65; C25B 15/02; C25B 15/06; H02M 1/32; H02M 7/219

(52) U.S. Cl. CPC H02M 1/36; C25B 1/04; C25B 9/65; C25B 15/02; C25B 15/06; H02M 1/32; H02M 7/219

(57) ABSTRACT

A method for starting an electrolysis system is disclosed. A supply circuit has an AC terminal connected to an AC grid, a DC terminal connected to an electrolyzer, and an AC/DC converter arranged between the AC terminal and the DC terminal. The method includes charging an output capacitor connected to a DC converter terminal of the AC/DC converter, by operating the electrolyzer in a reverse mode, while the AC/DC converter is connected to the electrolyzer and disconnected from the AC grid, connecting the AC/DC converter to the AC grid, reversing the operation of the electrolyzer from the reverse mode to a normal mode as a DC load, to suppress a power flow between the AC grid and the electrolyzer, and operating the electrolyzer in the normal mode with electrical power drawn from the AC grid which is rectified by the AC/DC converter.

### REFERENCE TO RELATED APPLICATIONS

This Application is a Continuation of International Application number PCT/EP2022/066781, filed on Jun. 21, 2022, which claims the benefit of European Application number 21183299.3, filed on Jul. 1, 2021. The contents of the above-referenced Patent Applications are hereby incorporated by reference in their entirety.

### FIELD

The disclosure relates to a method for the starting of an electrolysis system, and to an electrolysis system configured to carry out the method.

### BACKGROUND

It is known to use electrolysis systems for electrolytically generating hydrogen from water in the so-called power-to-gas method. In this case, the electrolyzer is connected via a supply unit operating as a rectifier to an AC voltage grid (AC grid), which supplies the electrolyzer with a DC voltage and also controls the hydrogen generation rate of the electrolyzer by way of a change in the DC voltage transferred to the electrolyzer. In this case, the hydrogen generation rate usually increases with a rising DC voltage present at the DC input of the electrolyzer and with an attendant drawing of power from the AC grid, at least in a certain operating range for the DC voltage.

A conventional supply unit operating as a rectifier includes an AC/DC converter, the bridge circuit of which has transistors each with a diode connected in antiparallel therewith as a freewheeling diode. The diodes may be a separate or an intrinsic diode—a so-called body diode—of the transistor. In order to avoid a current surge into a capacitor which is connected to the AC/DC converter on the DC side and is initially uncharged during the starting, the supply unit has both an AC-side and a DC-side precharge unit. The precharge unit typically comprises a series circuit formed by a precharge resistor and a precharge switch, and a switch connected in parallel with the series circuit. During starting of the electrolysis system, then, firstly the output capacitor connected to a DC converter terminal of the AC/DC converter is precharged by way of a current drawn from the AC grid and passed via the precharge resistor of the AC-side precharge unit. In this case, the precharge resistor serves for limiting the current into the uncharged output capacitor. When a voltage threshold value for the DC voltage present at the output capacitor is reached, the switch of the AC-side precharge unit is closed, whereby a low-impedance electrical connection of the AC/DC converter and the AC grid is established. After the output capacitor has been charged, the supply unit is electrically connected to the electrolyzer via the DC-side precharge unit. Since the electrolyzer has a predominantly capacitive behavior at low input voltages, and this behavior transitions to a resistive behavior only after a critical DC voltage U_{DC,Cr}—often also referred to as open circuit voltage—has been reached and exceeded, here as well the connection is effected firstly by way of closing the precharge switch in conjunction with an initially open switch of the DC-side precharge unit. In this case, a current that flows from the charged output capacitor to the electrolyzer is conducted via the precharge resistor of the DC-side precharge unit and is limited in terms of its current intensity by said precharge resistor. It is only in the event of reaching a further threshold value for a DC voltage present at the electrolyzer, or—this being tantamount to the same given a constant DC voltage across the output capacitor—in the event of undershooting a voltage drop across the precharge resistor, that the switch of the DC-side precharge unit is closed and the electrolyzer is connected with low impedance to the DC converter output of the AC/DC converter.

The output capacitor of the supply unit as well as the electrolyzer itself each have a high capacitance value. In order that a precharge of the capacitances is then concluded within a predefined time, precharge resistors having a high nominal power are required for both precharge units, which is associated with an enormous cost outlay. A method for the starting of an electrolysis system which is associated with a lower outlay is therefore desirable.

The document DE 10 2004 048 703 A1 discloses a device and a method for starting and operating a fuel cell system which is connectable to an AC grid. In that case, a bidirectional converter is provided, by way of which, during normal operation, a DC current generated by the fuel cell stack of the fuel cell system is converted into AC current for feeding into the AC grid. Conversely, during a starting process, an AC current of the fuel cell system made available by way of the AC grid is converted for feeding into a DC link circuit.

The document EP 3334003 A1 discloses a charging system and a method for operating same. The charging system comprises a power supply device, a battery module, and a charging module. The charging module is disconnectably connected to the power supply device and to the battery module and comprises a power converting unit. When the power supply device and the charging module are connected to each other, the power converting unit of the charging module is operated in the backward direction and electrical power of the battery module is used for precharging a bus capacitor. If the voltage of the bus capacitor is greater than or equal to a first threshold value owing to the precharging of said bus capacitor, the voltage at an adjusting terminal of the charging module is adjusted and the charging system is in a normal operating mode.

The document US 2017/0005357 A1 discloses a system comprising a Reversible Solid Oxide Fuel Cell (RSOFC) unit, a bidirectional AC/DC converter coupled to the RSOFC unit, and a common bus coupled to the bidirectional AC/DC converter and to a power grid. The RSOFC unit has a fuel cell mode and an electrolysis mode. The bidirectional AC/DC converter is configured to convert DC power generated by the RSOFC unit into AC power, and to convert AC power into DC power for consumption by the RSOFC unit in the electrolysis mode.

The document JP 2006156066 A discloses a fuel cell system having a main contactor, which changes over a connection state of a fuel cell with a load and an energy store, a precharge contactor connected in parallel with the main contactor, a sub-contactor arranged between the energy store and the load, a sub-contactor connecting device, which closes the sub-contactor when a starting command is received, a comparing means, which compares the voltage Vₑₛ on the load side with the voltage V_{fc} of the fuel cell after the sub-contactor is connected, and a main contactor connection means, which closes the main contactor without closing the precharge contactor when a decision is taken that the voltage Vₑₛ present at the load is greater than the voltage V_{fc} present at the fuel cell.

### SUMMARY

The disclosure addresses the problem of specifying a method for the starting of an electrolysis system which can be implemented with a significantly lower outlay than conventional methods. Specifically, the method is intended to enable starting of the electrolysis system as far as possible with just one precharge circuit or unit, optionally even without a precharge circuit or unit. The disclosure additionally addresses the problem of disclosing an electrolysis system suitable for carrying out the method.

In the case of a method according to the disclosure for the starting of an electrolysis system, the electrolysis system comprises an electrolyzer and a supply circuit or unit operating as a rectifier. In this case, the supply circuit or unit has an AC terminal connected to an AC grid, a DC terminal connected to the electrolyzer, and an AC/DC converter arranged between the AC terminal and the DC terminal. The method comprises the following acts:

charging an output capacitor, which is connected to a DC converter terminal of the AC/DC converter, by operating the electrolyzer in a reverse mode as a DC voltage source, while the AC/DC converter is in a state in which it is connected to the electrolyzer and disconnected from the AC grid,

connecting the AC/DC converter to the AC grid,

reversing the operation of the electrolyzer from the reverse mode as a DC voltage source to a normal mode as a DC load, wherein, during the reversing of the operation, a power flow between the AC grid and the electrolyzer is completely or at least largely suppressed, and

operating the electrolyzer in the normal mode as a DC load with electrical power which is drawn from the AC grid by way of the supply circuit or unit and which is rectified by way of the AC/DC converter.

In one embodiment, the output capacitor can be present as a component which is separate relative to the AC/DC converter but which is connected to the DC converter terminal of the AC/DC converter. In this case, it is not integrated into the AC/DC converter, not even partly. Alternatively, however, it is also possible for the output capacitor to be partly or else completely integrated into the AC/DC converter and thus to be partly or else completely comprised by the AC/DC converter. Connecting the AC/DC converter, for example, the AC converter output thereof, to the AC grid can be effected by way of closing an AC disconnection unit arranged between the AC/DC converter and the AC output. Similarly, disconnecting the AC/DC converter, for example, the DC converter output thereof and the output capacitor connected thereto, from the electrolyzer can be brought about by way of opening a DC disconnection unit arranged between the output capacitor and the DC output of the supply circuit or unit. In principle, it is possible for connecting the AC/DC converter to the AC grid to be effected at a time before, at the same time as, or at a time after, disconnecting the AC/DC converter from the electrolyzer. The charging of the output capacitor can already be completely concluded at a point in time at which the AC converter input is connected to the AC grid. This is not necessarily required, however. Rather, within the scope of the disclosure, it is also possible for the output capacitor still to be charged via the electrolyzer operating in the reverse mode even if the AC converter input has already been galvanically connected to the AC grid. Completely or at least largely suppressing the power flow between the AC grid and the electrolyzer ensures that during the reversing of the operation of the electrolyzer from its reverse mode to its normal mode, there is no uncontrolled power flow from the AC grid via the supply circuit or unit into the electrolyzer. Specifically, as described in detail later, such a power flow may have a disadvantageous influence on the reversing of the operation and may possibly damage electrodes of the electrolyzer as well. The point between AC grid and electrolyzer at which the power flow is suppressed is unimportant in this case. Specifically, it can be suppressed for example between the AC terminal of the supply circuit or unit and the output capacitor. As an alternative thereto, largely or completely suppressing the power flow can also be effected between the AC/DC converter and the DC terminal of the supply circuit or unit. A combination of a plurality of points at which the power flow is completely or at least largely suppressed is also possible.

In one embodiment, connecting the AC converter terminal to the AC grid can be effected largely without current, but at least with significantly reduced current. By way of example, before connecting the AC/DC converter to the AC grid, the output capacitor can be charged up to a voltage threshold value corresponding at least approximately to an amplitude of an AC voltage prevailing at the AC input of the supply circuit or unit. In this way, the diodes of the transistor-based bridge circuit of the AC/DC converter are present in their blocking state and a current surge from the AC grid into the output capacitor is suppressed to the greatest possible extent.

An electrolysis system according to the disclosure includes an electrolysis apparatus or unit comprising an electrolyzer, and a supply circuit or unit, which feeds the electrolyzer from an AC grid. In this case, the supply circuit or unit comprises an AC terminal for connection of an AC grid, a DC terminal for connection of the electrolyzer, and an AC/DC converter arranged between the AC terminal and the DC terminal. The supply circuit or unit furthermore comprises an AC disconnection unit for connecting an AC converter terminal of the AC/DC converter to the AC terminal of the supply circuit or unit, and a DC disconnection unit for connecting a DC converter terminal of the AC/DC converter to the DC terminal of the supply circuit or unit. In one embodiment, the electrolysis system according to the disclosure furthermore includes a control circuit or unit for the purpose of its control and is designed and configured for carrying out the method according to the disclosure.

The AC terminal of the supply circuit or unit—like the AC converter terminal of the AC/DC converter as well—is usually embodied in polyphase fashion and includes a plurality of phase conductor terminals. The supply circuit or unit can be designed in a manner capable of unbalanced-load operation. In this case, the AC terminal and respectively the AC converter terminal can also each have a neutral conductor terminal. Within the scope of the disclosure, however, it is also possible for the supply circuit or unit to be a supply circuit or unit which is not capable of unbalanced-load operation. In the case of a supply circuit or unit which is embodied in polyphase fashion and is not capable of unbalanced-load operation, it is possible for the AC terminal of the supply circuit or unit as well as the AC converter terminal of the AC/DC converter to have only a plurality of phase conductor terminals, but no neutral conductor terminal. Within the scope of the disclosure, it is additionally possible for the supply circuit or unit to be embodied only in single-phase fashion and for the AC terminal as well as the AC converter terminal each to comprise a phase conductor terminal and a neutral conductor terminal.

The disclosure makes use of the effect that specific types of electrolyzers can also operate in a so-called reverse mode in addition to their normal mode. In the normal mode of the electrolyzer, the electrolyzer is operated as a DC load, which for its part requires a DC source providing a DC voltage as the energy supply. The electrolysis reaction takes place in the normal mode, in which reaction water (H₂O) is decomposed into its elementary constituents hydrogen (H₂) and oxygen (O₂), with electrical power being consumed. The electrical power is drawn from the AC grid via the supply circuit or unit, rectified and fed as rectified electrical power to the electrolyzer for the supply thereof. In the reverse mode, by contrast, the electrolyzer itself operates as a DC source and for its part provides an electrical energy in the form of a DC voltage for another DC load. Examples of electrolyzers having such a reverse mode are electrolyzers comprising solid oxide electrolysis cells (SOEC), or so-called proton exchange membrane (PEM) electrolyzers. Both operating modes, normal mode and reverse mode, as well as a transition or reversing of operation from the reverse mode to the normal mode will be explained in detail again on the basis of the example of an electrolyzer comprising solid oxide electrolysis cells in association with FIGS. 3a to 3b, for which reason reference is made to the corresponding description of the figures at this juncture.

By virtue of the electrolyzer now operating in its reverse mode, within the scope of the disclosure, charging the output capacitor of the supply circuit or unit can now be effected by means of an electrical power drawn from the electrolyzer, rather than by means of an electrical power drawn from the AC grid. This applies at least to an initial part of the charging from the zero voltage state of the output capacitor, but optionally also to the complete charging of the output capacitor. For a power flow from the electrolyzer into the output capacitor, the output capacitor—at least initially—is galvanically connected only to the electrolyzer and—together with the AC/DC converter connected to the output capacitor—is galvanically isolated from the AC grid. In this embodiment, the galvanic isolation can be brought about by way of the open AC disconnection circuit or unit between the AC input and the AC/DC converter.

If the output capacitor has been charged sufficiently, optionally also completely, the electrolyzer can be disconnected from the output capacitor and thus from the AC/DC converter. By virtue of the electrolyzer and the AC/DC converter being disconnected from one another, a power flow between the AC/DC converter and the electrolyzer is completely suppressed. If the electrolyzer is connectable to the AC/DC converter both via a low-impedance connection and via a high-impedance connection, it is sufficient if only the low-impedance connection, but not the high-impedance connection, is disconnected during the reversing of operation. In this case, the power flow between the AC/DC converter and the electrolyzer is not completely suppressed, but at least largely suppressed. Furthermore, the AC/DC converter can be connected to the AC grid. In this case, however, connecting to the AC grid by way of closing the AC disconnection circuit or unit can be effected without a current flow, at least without an appreciable current flow from the AC grid into the output capacitor. After the AC/DC converter has been connected to the AC grid, a power flow from the AC grid into the output capacitor can take place. Components of the supply circuit or unit which are supplied from the output capacitor and previously obtained their supply power from the electrolyzer operating in the reverse mode can now be supplied from the AC grid. Examples of such components which are supplied from the output capacitor are the control unit of the supply circuit or unit or other small consumers, for example fans, etc.

Reversing the operation of the electrolyzer from its reverse mode to its normal mode is usually associated with a more or less pronounced decrease in the DC voltage present at the terminal of the electrolyzer. In one embodiment of the method, reversing the operation of the electrolyzer from its reverse mode to its normal mode can now be effected in a state in which the AC converter terminal of the AC/DC converter is connected to the AC grid and also the DC converter terminal of the AC/DC converter is connected to the electrolyzer. In this case, therefore, both the AC disconnection circuit or unit and the DC disconnection circuit or unit can be present in their respective closed states. This can be carried out, for example, if it is foreseeable that a reduction of a DC voltage at the terminal of the electrolyzer as a consequence of reversing the operation does not undershoot or will not undershoot a rectified value of the DC/AC converter. This is because undershooting the rectified value would result in an uncontrollable current flow from the AC grid via diodes of the AC/DC converter, preventing a further decrease in the DC voltage at the output capacitor. This in turn may have a disadvantageous influence on the reversing of the operation of the electrolyzer from the reverse mode to the normal mode, and may in addition possibly irreversibly damage the electrodes of the electrolyzer as well. If, however, the rectified value of the AC/DC converter is not undershot during the reversing of operation despite the temporary dip in the DC voltage present at the terminal of the electrolyzer, then the diodes of the AC/DC converter are present in their respective blocking state and such an uncontrollable current flow from the AC grid via the diodes of the AC/DC converter cannot take place if only on account of the blocking effect of the diodes, for example, not even if the AC/DC converter remains connected, for example, even connected with low impedance, to the electrolyzer via a closed DC disconnection unit. Specifically, in this case, a complete suppression of the power flow between the AC/DC converter and the electrolyzer during the reversing of the operation thereof is effected by virtue of the diodes of the AC/DC converter being present in their respective blocking state on account of the relationship between the DC voltage at the electrolyzer and the rectified value of the AC/DC converter connected to the AC grid. After the operation of the electrolyzer has been reversed, if the electrolyzer is intended to be operated in its normal mode, a clocking of the AC/DC converter can be changed such that, by way of this clocking, the DC voltage present at the output capacitor—and, in the state in which output capacitor and terminal of the electrolyzer are galvanically connected, likewise the DC voltage present at the terminal of the electrolyzer—is varied and in particular raised.

An alternative embodiment of the method can be applied if it is foreseeable that reversing the operation of the electrolyzer undershoots or threatens to undershoot the rectified value of the AC/DC converter. In accordance with this alternative embodiment, for reversing the operation, for example, before reversing the operation or else during this, disconnecting the AC/DC converter from the electrolyzer can be effected. Reversing the operation of the electrolyzer from the reverse mode to the normal mode can then be effected partly or completely while the electrolyzer is in a state in which it is disconnected from the AC/DC converter. The AC/DC converter can be connected, for example, connected with low impedance, to the electrolyzer again after reversing the operation has been effected. In this case, a possibly higher DC voltage at the output capacitor on account of the disconnection of AC/DC converter and electrolyzer has no influence on the DC voltage present at the terminal of the electrolyzer and, consequently, can neither have a disadvantageous influence on reversing the operation of the electrolyzer nor damage the electrodes of the electrolyzer. Disconnecting the electrolyzer from the AC/DC converter can be effected by way of the DC disconnection circuit or unit of the supply circuit or unit. In this case, the disconnection can be carried out as all-pole or only single-pole disconnection, depending on the embodiment of the DC disconnection unit. In both cases, the power flow between the AC/DC converter and the electrolyzer is completely suppressed in the disconnected state of the DC disconnection circuit or unit.

A further embodiment of the method can be applied if the AC/DC converter is connectable to the electrolyzer via two connections, namely both via a low-impedance connection and via a high-impedance connection. This is the case, for example, if the DC disconnection unit (as also described in association with FIG. 1) has a precharge circuit. The precharge circuit can comprise a first path having a series circuit formed by a precharge resistor and a precharge switch, and a second path having a further switch. In this case, the second path is arranged in parallel with the first path. In this case, the first path represents the high-impedance connection, and the second path the low-impedance connection. It now lies within the scope of the disclosure that for reversing the operation, only disconnecting the low-impedance connection of the AC/DC converter from the electrolyzer is effected, but disconnecting the high-impedance connection is not effected. In this case, reversing the operation of the electrolyzer from the reverse mode to the normal mode is effected in a disconnected state of the low-impedance connection between the AC/DC converter and the electrolyzer. The AC/DC converter is connected to the electrolyzer with low impedance again after reversing the operation has been effected. The state in which the DC disconnection circuit or unit is disconnected with low impedance but connected with high impedance results in the power flow between the AC/DC converter and the electrolyzer being at least largely suppressed. Depending on the choice of precharge resistor, however, it has been found that this is already sufficient to enable the reversing of the operation of the electrolyzer to be carried out without hindrance and without damage of its electrodes.

Reversing the operation of the electrolyzer from its reverse mode to its normal mode can be effected by way of a change of starting substances (starting materials) which are fed to the electrodes (anode and cathode) of the electrolysis cells. After reversing the operation has been effected, the electrolysis cells of the electrolyzer have an open circuit voltage which is dependent on the number of electrolysis cells connected in series and typically lies in a range of 0.8 V-1.2 V per cell. Electrolysis does not take place yet, however, since with the presence of the open DC disconnection circuit or unit, the electrolyzer is still disconnected from the DC converter terminal of the AC/DC converter and thus from the electrical power supply that drives the electrolysis reaction. In order to bring about the normal mode of the electrolyzer, the electrolyzer is finally galvanically connected to the DC converter output and the output capacitor connected thereto. In this case, the open circuit voltage of the electrolyzer can be matched beforehand to the DC voltage present at the output capacitor of the supply circuit or unit in order to reduce a compensating current that flows otherwise. This can be done at the electrolyzer for example by way of changing the composition of the starting materials supplied to the electrodes. After connection, in particular low-impedance connection, of the electrolyzer to the AC/DC converter of the supply circuit or unit has been effected, the electrolyzer is operated in the normal mode and the electrolysis reaction of the electrolyzer is controlled in a manner known per se by way of a DC voltage that is present at the electrolyzer and is generated by the supply circuit or unit.

Since the charging of the output capacitor is effected to the greatest possible extent by way of the electrolyzer and not from the AC grid, it is possible to dispense with an AC-side precharge circuit with a corresponding precharge resistor within the AC disconnection unit. If an AC-side precharge unit is nevertheless still desired, it can however be designed in a simple and cost-effective manner with regard to its current-carrying capacity. By way of example, a nominal power of an AC-side precharge resistor can be significantly reduced. In certain cases it is even possible in addition also to dispense with a DC-side precharge circuit with a corresponding precharge resistor. Overall the outlay for the supply circuit or unit as well as for the electrolysis system comprising the supply circuit or unit can be minimized.

In accordance with one advantageous embodiment of the method, the output capacitor can be charged to a DC voltage U_{DC,4} whose value corresponds to at least a rectified value or at least the amplitude of the AC voltage U_{AC} present at the AC terminal. Depending on the type of AC terminal, the AC voltage can be a differential voltage of the phase conductors of the AC grid or a voltage between each phase conductor and the neutral conductor. The former is the case if the AC terminal of the supply circuit or unit as well as the AC converter terminal have only phase conductor terminals, but no neutral conductor terminal. The latter is the case if the AC terminal as well as the AC converter terminal also have a neutral conductor terminal in addition to the phase conductor terminals. Irrespective of the type of AC terminal, such charging of the output capacitor ensures that the diodes of the AC/DC converter are present in their blocking state or are rapidly changed over to this state. Specifically, for example, an LC filter can be arranged between the AC disconnection unit and the AC converter output, the capacitors of which filter are as yet uncharged and become charged when the AC disconnection circuit or unit is closed. However, since a capacitance of the filter capacitors is typically significantly lower than that of the output capacitor, the compensating current that flows for the filter capacitors likewise turns out to be so low that it is tolerable even without additional current limiting means. Overall it is possible to significantly reduce a power flow from the AC grid when the AC disconnection circuit or unit is closed.

In a further embodiment, the output capacitor can be charged to a DC voltage U_{DC,4} whose value corresponds to at least double the amplitude of the AC voltage UAC present at the AC terminal. Here, too, depending on the embodiment of the AC terminal, the voltage can be a differential voltage of two phase conductors or a voltage of one of the phase conductors relative to the neutral conductor. In the case of such a DC voltage of the output capacitor, before connecting the AC/DC converter to the AC grid, an AC voltage can be generated by the AC/DC converter and synchronized with an AC voltage U₁₁ present at the AC terminal of the supply circuit or unit. The AC voltage can be generated by way of corresponding clocking of the transistors of the AC/DC converter. This is advantageous particularly if a passive filter, for example, an LC filter or an LCL filter, is arranged between AC disconnection circuit or unit and AC/DC converter. This is because in this way filter capacitors of the passive filter, on the part of the AC/DC converter, can already be charged in a controlled manner before the AC disconnection circuit or unit is closed. Connecting the AC/DC converter to the AC grid by closing the AC disconnection circuit or unit can thus be effected virtually without power or without current.

During the generation of the AC voltage by the AC/DC converter for the purpose of synchronization, power loss is generated by the AC/DC converter, which—if the AC disconnection circuit or unit is still open—is drawn from the output capacitor. If the DC disconnection circuit or unit were also open, the DC voltage present at the output capacitor would therefore decrease. In one advantageous embodiment of the method, it is possible for disconnecting the AC/DC converter from the electrolyzer or disconnecting the low-impedance connection between the AC/DC converter and the electrolyzer to be effected only if the AC/DC converter is connected to the AC grid, i.e. the AC disconnection circuit or unit is closed. This enables recharging of the output capacitor and thus compensation of the power loss generated by the AC/DC converter by way of the electrolyzer operating in the reverse mode. Consequently, during synchronization and also until synchronization has been effected, an uninterruptible supply firstly of the AC/DC converter and also of further components of the supply circuit or unit that are possibly supplied electrically by way of the output capacitor is reliably ensured. After the closing of the AC disconnection circuit or unit and the then existing electrical connection to the AC grid, a power flow into the output capacitor and also an electrical supply of the components connected thereto from the AC grid can be effected. Afterward, the DC disconnection circuit or unit can then be opened and the electrolyzer can be put into the normal mode from the reverse mode as a result of reversing the operation.

In accordance with one embodiment, the electrolyzer can be connected to the output capacitor of the supply circuit or unit while the terminal of the electrolyzer is in a state in which it is at least largely free of voltage—i.e. at approximately 0 V and before the electrolyzer is actually put into the reverse mode—and the electrolyzer can be put into its reverse mode while in a state connected to the supply circuit or unit. Since the supply circuit or unit usually has both an open AC disconnection circuit or unit and an open DC disconnection circuit or unit before the starting of the electrolysis system, the output capacitor, too, is initially free of voltage. Therefore, there is no, but at least merely a negligible, voltage difference between the DC voltages present at the terminal of the electrolyzer and the output capacitor. Consequently, the connection between the two also generates no, possibly only a negligible, compensating current. In order to carry out the reversing of the operation, the electrolyzer can then be disconnected from the charged output capacitor. This is not absolutely necessary, but is advantageous if reversing the operation into the normal mode is associated with a significant decrease in the DC voltage present at the terminal of the electrolyzer, such that this voltage undershoots a rectified value of the AC/DC converter connected to the AC grid. Specifically, if the DC voltage at the terminal of the electrolyzer undershoots the rectified value of the AC/DC converter, then given a closed state of the DC disconnection circuit or unit and a closed state of the AC disconnection circuit or unit, this would result in a current flow from the AC grid which may have a disadvantageous influence on carrying out the reversing of the operation and may possibly damage the electrodes of the electrolyzer. After reversing the operation has been effected, the electrolyzer is present in a state in which it is prepared for its normal mode. However, since initially, at least in one embodiment, the electrolyzer is still disconnected from the AC/DC converter by the open DC disconnection circuit or unit, the open circuit voltage is present at its terminal. Depending on the media supplied, for example, depending on their partial pressure and their temperature, optionally also depending on a temperature of the electrolysis cells, the open circuit voltage of the electrolyzer can be varied within certain limits, however. Consequently, the DC voltage at the terminal of the electrolyzer can be matched to the DC voltage present at the output capacitor, for which reason, in certain cases, a DC-side precharge unit can additionally also be dispensed with. By contrast, if it is foreseeable that upon reversing the operation from the reverse mode to the normal mode, the DC voltage at the terminal of the electrolyzer does not undershoot the rectified value of the AC/DC converter connected to the AC grid, then reversing the operation can also be effected in a state in which the DC disconnection circuit or unit is closed and the DC converter terminal and the output capacitor are thus connected to the terminal of the electrolyzer.

In accordance with a further embodiment of the method, however, after reversing the operation of the electrolyzer has been effected and before the closing of the DC disconnection circuit or unit, there may still be a significant voltage difference between the terminal of the electrolyzer and the output capacitor. Specifically, for example, the electrolyzer may have been put into its reverse mode while in a state disconnected from the output capacitor, and the output capacitor may be present still in a manner largely free of voltage. Alternatively or cumulatively, it is also possible that the electrolyzer was put into the reverse mode in a state connected to the output capacitor, but matching the DC voltages between the terminal of the electrolyzer and the output capacitor after reversing the operation has been effected is not sufficiently possible. Specifically, therefore, a DC voltage different than 0 V can be present at the terminal of the electrolyzer, which voltage is, for example, close to an open circuit voltage that is characteristic of the open circuit mode of the electrolyzer (U_{DC,EI}22 0V), while the output capacitor can be present in a charged manner (U_{DC,4}>0) or in a manner largely free of voltage (U_{DC,4}≈0V). In such cases, and particularly if a difference between the characteristic open circuit voltage of the electrolyzer U_{DC,EL} and the DC voltage present at the output capacitor exceeds a threshold value, the terminal of the electrolyzer can be connected to the output capacitor via a current-limiting precharge resistor. For this purpose, in the case of the electrolysis system, the DC disconnection circuit or unit of the supply circuit or unit can have a series circuit formed by a precharge resistor and a precharge switch, and also a switch arranged in parallel with the series circuit. As an alternative thereto, it is possible for the terminal of the electrolyzer, given a DC voltage different than 0 V present at it, to be connected to the output capacitor via a DC/DC converter. In order to realize this last, the electrolysis system, for example the DC disconnection circuit or unit of the supply circuit or unit, can have a DC/DC converter designed to step down a DC voltage prevailing at the terminal of the electrolyzer in the direction of the output capacitor. In both embodiments (precharge resistor or DC/DC converter), a compensating current that arises from the electrolyzer into the uncharged, or not yet sufficiently charged, output capacitor is reliably limited to a value that is noncritical for the affected components.

In accordance with one embodiment of the electrolysis system, the supply circuit or unit can have voltage sensors. The voltage sensors can be configured to detect an AC voltage dropped across the AC disconnection unit and/or a DC voltage dropped across the DC disconnection circuit or unit. It is possible for the voltage sensors to directly detect the voltage dropped across the respective disconnection unit. Alternatively, it is also possible that on each contact side of the disconnection circuits or units, in each case a voltage measurement relative to a reference potential is effected and then the voltages are subtracted from one another. The voltage sensors can cooperate with the control circuit of the electrolysis system, the control circuit of the supply circuit or unit and/or the control circuit of the electrolysis unit in such a way that the DC disconnection circuit or unit is closed depending on the detected DC voltage. Similarly, the AC disconnection circuit or unit can also be closed depending on the detected AC voltage.

In one embodiment of the electrolysis system, the control circuit thereof can be embodied as a separate and central control circuit designed both for controlling the supply circuit or unit and for controlling the electrolysis unit. As an alternative thereto, it is possible for the control circuit of the electrolysis system to be at least partly, optionally also fully, integrated into a control circuit—present anyway—of the supply circuit or unit and/or a control circuit of the electrolysis unit. In this case, all control circuits (that of the supply circuit, that of the electrolysis unit and optionally that of the electrolysis system) can be connected to one another communicatively and in terms of control engineering.

In one embodiment of the electrolysis system, the AC/DC converter of the supply circuit or unit can be designed for a bidirectional power flow, which can exchange electrical active power with the AC grid in both directions. Moreover, it can be designed to exchange capacitive reactive power as well as inductive reactive power with the AC grid. The AC/DC converter can have a transistor-based bridge circuit, i.e. a bridge circuit having a plurality of transistors each with a diode connected in antiparallel therewith. It is possible for the supply circuit or unit to have means for interference current damping. By way of example, the supply circuit or unit can comprise a passive filter having inductances and filter capacitances for filtering clock-frequency interference currents. The filter can be in particular an LC filter or an LCL filter.

The electrolyzer must have certain properties in order to be able to be used as an electrolyzer within the electrolysis system. Specifically, it must firstly be designed to operate in a normal mode in which an electrolysis reaction, for example, an electrolysis reaction of water into hydrogen and oxygen, takes place. Moreover, the electrolyzer must be designed, in a reverse mode, to provide electrical energy from a chemical energy carrier and thus to operate as a DC source. Examples of electrolyzer types which realize these operating modes are electrolyzers based on solid oxide electrolysis cells (SOEC electrolyzer) or proton exchange membrane electrolyzers (PEM electrolyzer). Therefore, the electrolyzer of the electrolysis system can advantageously be embodied as an electrolyzer comprising solid oxide electrolysis cells, i.e. as a solid oxide electrolyzer. Alternatively, it is also possible for the electrolyzer to be embodied as a proton exchange membrane electrolyzer (PEM electrolyzer).

### BRIEF DESCRIPTION OF THE FIGURES

The disclosure is illustrated below with the aid of figures. In the figures:

FIG. 1 shows one embodiment of an electrolysis system according to the disclosure;

FIG. 2 shows a flow diagram of one embodiment of the method according to the disclosure such as can be carried out by means of the electrolysis system from FIG. 1;

FIG. 3a shows a schematic illustration of the reverse mode on the basis of the example of a solid oxide electrolysis cell (SOEC);

FIG. 3b shows a schematic illustration of the normal mode on the basis of the example of the solid oxide electrolysis cell (SOEC) from FIG. 3a.

### DETAILED DESCRIPTION

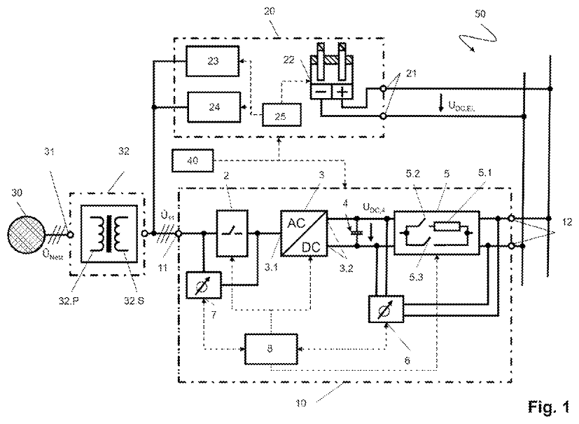

FIG. 1 illustrates one embodiment of an electrolysis system 50 according to the disclosure. The electrolysis system 50 includes an electrolysis unit 20, a supply circuit or unit 10 and a separate control circuit 40 that is configured to coordinate control of the electrolysis unit 20 and the supply circuit or unit 10. For this purpose, the control circuit 40 is connected to the electrolysis unit 20 and the supply circuit or unit 10, for example, to their control circuits 8, 25, in terms of control engineering. The supply circuit or unit 10 is connected by its AC terminal 11 to an AC grid 30 via a transformer 32 and a grid terminal point 31. By way of example, the AC grid 30 is a three-phase medium-voltage grid which provides an AC voltage having the amplitude Û_{Netz} at a primary side 32.P of the transformer 32. The transformer 32 converts the AC voltage present at the primary side into a three-phase AC voltage having the amplitude Û₁₁, which is present at a secondary side 32.S of the transformer 32 and at the AC terminal 11 of the supply circuit or unit 10.

Between the AC terminal 11 and the DC terminal 12 of the supply circuit or unit 10, in the direction from the AC terminal 11 to the DC terminal 12 there are arranged an AC disconnection circuit 2, an AC/DC converter 3 having an AC converter terminal 3.1 and a DC converter terminal 3.2, an output capacitor 4 and a DC disconnection circuit 5. The DC disconnection circuit 5 comprises a precharge path having a series circuit formed by a precharge resistor 5.1 and a precharge switch 5.2. A further switch 5.3 is arranged in parallel with the series circuit comprising precharge resistor 5.1 and precharge switch 5.2. As an alternative thereto, however, it is also possible for the DC disconnection circuit 5 to comprise a DC/DC converter. The supply circuit or unit 10 comprises a first voltage sensor 6 designed to detect a DC voltage dropped across the DC disconnection circuit 5. It furthermore comprises a second voltage sensor 7 for detecting an AC voltage dropped across the AC disconnection circuit 2. Both voltage sensors 6, 7 are connected to the control circuit 8 of the supply circuit or unit 10. The control circuit 8 of the supply circuit or unit 10 is connected to the AC disconnection circuit 2 and the DC disconnection circuit 5 in terms of control engineering. The control engineering connections are symbolized by means of dashed lines in FIG. 1. The control circuit 8 is configured to control the AC disconnection circuit 2 and the DC disconnection circuit 5 depending on the voltages detected by means of the voltage sensors 6, 7. It is furthermore additionally configured to control the AC/DC converter 3. The AC/DC converter 3 has a transistor-based bridge circuit and is operable bidirectionally in regard to a direction of the power flow. Specifically, it is designed firstly to operate as a rectifier and in so doing to convert an AC voltage present at its AC converter terminal 3.1 into a DC voltage U_{DC,4} present at its DC converter terminal 3.2 and the output capacitor 4 connected thereto. Secondly, it is configured to operate as an inverter and in so doing to convert a DC voltage U_{DC,4} present at the output capacitor 4 and at its DC converter terminal 3.2 into an AC voltage present at its AC converter terminal 3.1. It is additionally able to exchange capacitive and inductive reactive power with the AC grid 30.

The electrolysis unit 20 includes an electrolyzer 22, auxiliary devices for operating the electrolyzer 23, 24, and a control circuit 25 configured to control the auxiliary devices and optionally the electrolyzer 22. The auxiliary devices can be controlled in such a way that during each operating state of the electrolyzer 22 (for example, during the reverse mode, the reversing of operation, and the normal mode), the media and ambient conditions required in each case for the electrochemical reaction to proceed within the electrolysis unit 20 are available or are present. In FIG. 1, the electrolyzer 22 is illustrated by way of example as a solid oxide electrolysis cell-based electrolyzer (SOEC electrolyzer) comprising solid oxide electrolysis cells (SOEC). As auxiliary devices of the SOEC electrolyzer, a gas supply device 23 for feeding in and/or discharging the media required for the chemical reaction (starting materials and products), and also a heating device 23 for heating the electrolysis cells of the electrolyzer 22 and/or the media fed in are illustrated by way of example in FIG. 1. In this case, the gas supply device 23 and the heating device 24 are supplied by way of the AC voltage having the amplitude Û₁₁ generated by the transformer 32 at the secondary side, which is also present at the AC terminal 11 of the supply circuit or unit 10. The electrolysis unit 20 or the electrolyzer 22 is electrically connected to the DC terminal 12 of the supply circuit or unit 10 via a terminal 21.

The electrolysis system 50 can include further components that are not explicitly illustrated in FIG. 1 and that may not be needed for explaining the present disclosure. By way of example, the supply circuit 10 can include a filter for damping undesired interference currents into the AC grid 30. In this case, the filter can have inductances and filter capacitances connected thereto and can be arranged between the AC disconnection circuit 2 and the AC/DC converter 3, for example. Even if the supply circuit or unit 10 is embodied as a three-phase supply circuit or unit by way of example in FIG. 1, it can also have a different number of phase conductors or phase conductor terminals. In this case, it is also possible for the supply circuit or unit to be configured as a single-phase supply circuit or unit. The AC grid 30 need not necessarily be a medium-voltage grid. Rather, it is also possible for the AC grid 30 to correspond to a low-voltage grid. In such a case, the transformer 32 can also be omitted and the supply circuit or unit 10 can be directly connected to the AC grid 30.

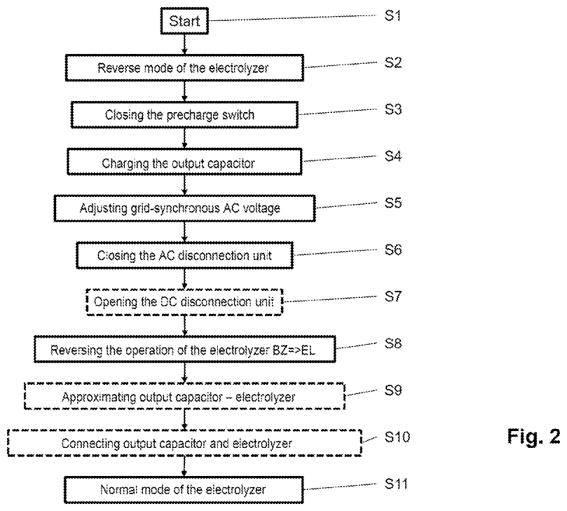

FIG. 2 schematically illustrates one embodiment of the method for operating the electrolysis system, for example the electrolysis system 50 from FIG. 1, in the form of a flow diagram. The method starts with act S1. In this embodiment, firstly the AC converter terminal 3.1 of the AC/DC converter 3 is disconnected from the AC terminal 11 of the supply circuit or unit 10—and thus from the AC grid 30—by way of the open AC disconnection circuit 2. The DC converter terminal 3.2 and the output capacitor 4 are also disconnected from the DC terminal 12 of the supply circuit or unit 10 and thus from the terminal 21 of the electrolyzer 22 by way of the open DC disconnection circuit 5 (both precharge switch 5.2 and further switch 5.3 are open). In a second act S2, the electrolyzer 22 is put into its reverse mode by way of the control circuit of the electrolysis system 40 and, connected thereto, the control circuit of the electrolysis unit 25. In the reverse mode, with suitable media being fed in, the electrolyzer 22 operates as a fuel cell and thus as a DC source. In this case, the electrolysis cells, optionally also the media fed in, are heated by way of the heating device 24 and the media are fed to the electrolysis cells of the electrolyzer 22 by way of the gas supply device 23. This is possible since the auxiliary devices, here: the gas supply device 23 and the heating device 24, are supplied by way of the AC voltage present at the secondary side of the transformer 32.S. In the reverse mode, a DC voltage is generated at the terminal 21 of the electrolyzer 22, and is also present at the DC terminal 12 of the supply circuit or unit 10.

In a further act S3, the precharge switch 5.2 of the DC disconnection circuit 5 is closed, as a result of which, in a fourth act S4, the output capacitor 4 is charged by way of a current limited by the precharge resistor 5.1. The output capacitor 4 is charged here at least to a value amounting to double the amplitude Û₁₁ of the AC voltage present at the AC terminal 11. In this case, if a threshold value of the DC voltage dropped across the DC disconnection circuit 5 is undershot, the further switch 5.3 of the DC disconnection circuit 5 can be closed and the electrolyzer 22 can be connected with low resistance to the DC converter terminal 3.2 and the output capacitor 4. In a fifth act S5, an AC voltage having an amplitude corresponding at least approximately to the amplitude Û₁₁ is generated by way of corresponding clocking of the AC/DC converter 3, the clocking being controlled by the control circuit 8. Furthermore, the AC voltage generated by the AC/DC converter 3 is synchronized, both with regard to its amplitude and with regard to its phase angle, with the AC voltage present at the AC terminal 11. In this case, a progression of the synchronization can be observed by means of the first voltage sensor 7, which detects the AC voltages present at both terminals of the AC disconnection circuit 2 and transfers these voltages to the control circuit 8. During the progression of the synchronization, the DC disconnection circuit 5 is closed and so a power loss of the AC/DC converter 3 that is drawn from the output capacitor 4 can continue to flow on the part of the electrolyzer operating in the reverse mode and can thus be compensated for. The DC voltage U_{DC,4} present at the output capacitor 4 can thus be kept constant.

Given sufficient synchronization, the AC disconnection circuit 2 is closed in a sixth act S6, which can be effected virtually without current and thus temperately for the AC disconnection circuit 2 on account of the synchronization. Since recharging of the output capacitor 4 from the AC grid 30 is ensured when the AC disconnection circuit 2 is closed, in a seventh act S7 the DC disconnection circuit 5 (here: precharge switch 5.2 and further switch 5.3) can be opened, as a result of which the electrolyzer 22 is galvanically isolated from the DC converter terminal 3.2 and the output capacitor 4. The seventh act S7 is merely an optional act, which is symbolized by a dashed surrounding box illustrated in FIG. 2. This act is advantageous particularly if it is foreseeable that reversing the operation is associated with a significant reduction of the DC voltage U_{DC,EL} present at the terminal of the electrolyzer 22, such that this voltage may fall below a rectified value of the AC/DC converter 3 connected to the AC grid 30. An eighth act S8 involves reversing the operation of the electrolyzer 22, which is controlled by way of the central control circuit 40 of the electrolysis system 50 in conjunction with the control circuit 25 of the electrolysis unit 20. Reversing the operation of the electrolyzer 22 from its reverse mode as a fuel cell BZ to its normal mode as an electrolyzer EL can be effected in a state in which the electrolyzer 22 is galvanically isolated from the DC converter terminal 3.2 and the output capacitor 4. With the DC disconnection circuit 5 open, in an optional ninth act S9, an open circuit voltage that forms at the terminal 21 of the electrolyzer 22 as DC voltage U_{DC,EL} can be approximated to (synchronized with) the DC voltage U_{DC,4} present at the output capacitor 4. If the two DC voltages U_{DC,EL} and U_{DC,4} have been approximated or synchronized, the DC disconnection circuit 5 can then be closed in an optional tenth act 510, as a result of which the DC converter terminal 3.2 of the AC/DC converter is connected with low impedance to the electrolyzer 22. If the DC disconnection circuit 5 is closed, it is possible, depending on the type of synchronization effected, to close firstly just the precharge switch 5.2 and only afterward the further switch 5.3. If the voltage difference of the DC voltages is sufficiently small, however, sequential closing of the precharge switch 5.1 and the further switch 5.3 can be dispensed with and the further switch 5.3 can be closed directly. The ninth and tenth acts S9, 510 are required only if the DC disconnection circuit was actually opened in the seventh act S7. Accordingly, their optional property is likewise symbolized by a dashed surrounding box illustrated in FIG. 2. In an eleventh act 511, under the control of the central control circuit 40 in conjunction with the control circuits 8, 25 of supply circuit or unit 10 and electrolysis unit 20, the electrolyzer 22 resumes its normal mode in which the electrolytic decomposition of water H₂O into its constituents oxygen O₂ and hydrogen H₂ takes place.

The flow diagram in FIG. 2 was explained on the basis of the example of the electrolysis system 50 from FIG. 1, in which the DC disconnection unit 5 comprises a precharge circuit having a precharge resistor 5.1. However, the flow diagram is also applicable in slightly modified form to a DC disconnection circuit having, as precharge circuit for the output capacitor 4, a DC/DC converter that steps down from the electrolyzer 22 in the direction of the output capacitor 4. Specifically, the previously deactivated DC/DC converter would then be activated in the third act S3, deactivated in the seventh act S7 and activated again, and optionally bridged with low resistance by way of a switch bridging the DC/DC converter in parallel, in the tenth act S10.

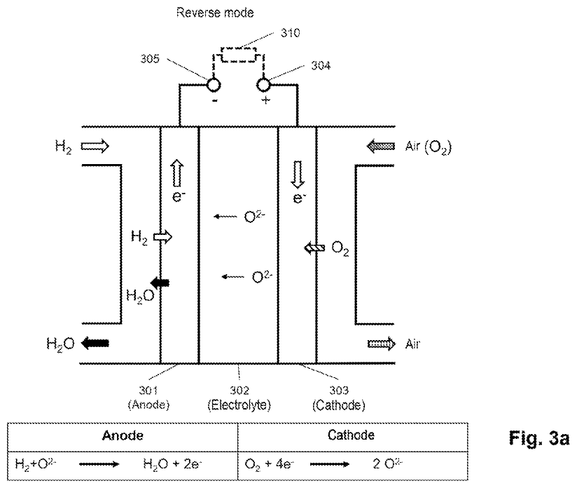

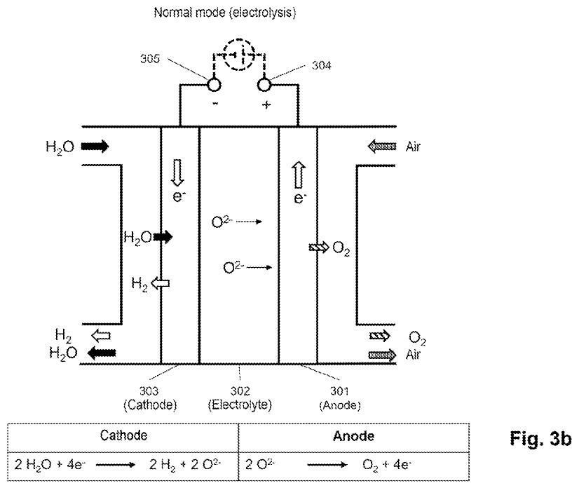

In FIG. 3a, the reverse mode of the solid oxide electrolyzer 22 from FIG. 1 is described in detail, with the processes that proceed in the solid oxide electrolysis cells of the SOEC electrolyzer 22 being illustrated schematically. In the reverse mode, the electrolyzer operates as a DC source and generates a DC voltage at its terminals 304, 305, corresponding to those of the terminal 21 from FIG. 1. A DC load 310 illustrated in a dashed manner in FIG. 3a can be supplied with the DC voltage. In the context of the method described with reference to FIG. 1 and FIG. 2, the DC load 310 is principally formed by the output capacitor 4 to be charged and/or the precharge resistor 5.1 of the DC disconnection circuit 5.

In the reverse mode, an oxygen-containing gas, e.g. air drawn from the surroundings and filtered, is provided at cathodes 303 of the electrolysis cells and hydrogen H₂ as fuel gas is provided at anodes 301 of the electrolysis cells. In this case, the hydrogen molecules Hare firstly oxidized to form positively charged hydrogen ions H⁺ at the anodes 301 with electrons being released to the anodes 301. The electrons flow via the externally connected DC load 310 to the cathodes. At the cathodes 303, the oxygen molecules O₂ present there, which are provided from the air, take up two electrons e⁻ each and are reduced to form doubly negatively charged oxygen ions O²⁻. The negatively charged oxygen ions O²⁻ diffuse on account of the concentration gradient through an electrolyte 302 of the electrolysis cells in the direction of the anodes 301, where they react with the positively charged hydrogen ions H⁺ present there to form molecular water H₂O. The water H₂O is pumped away in the form of water vapor together with the residual gases (e.g. unconsumed fuel gas) present at the anodes 301, or is purged from the anodes 301 by the fuel gas fed in. On the side of the cathodes 303, the consumed, oxygen-enriched air is purged from the cathodes 303 by the air fed in. The partial chemical reactions illustrated in the table in FIG. 3a thus arise at the anodes 301 and cathodes 303:

i. Anode: H₂+O²⁻⇒H₂O+2 e⁻

ii. Cathode: O₂+4e⁻⇒2 O²⁻

FIG. 3b illustrates the normal mode of the SOEC electrolyzer 22 together with the processes that proceed in the electrolysis cells. In the normal mode, the electrolyzer 22 is connected with low resistance to the DC converter terminal 3.2 and the output capacitor 4 via the closed DC disconnection circuit 5. The AC disconnection circuit 2 of the supply circuit or unit 10 is also closed and the AC/DC converter 3 operates as a rectifier which draws electrical power from the AC grid 30 and makes the rectified electrical power available to the electrolyzer 22 for carrying out the electrolysis reaction.

In the normal mode, the electrolyzer 22 operates as a DC load which is supplied electrically by the supply circuit or unit 10, for example, the AC/DC converter 3 thereof. In this respect, the combination of AC grid 30, AC/DC converter 3 and output capacitor 4 is symbolized in FIG. 3c by the DC source 311 connected to the terminals 304, 305, said DC source being illustrated in a dashed manner.

In the normal mode of the electrolyzer 22, water H₂O in the form of water vapor is provided at the cathodes 303. There the water molecules are split into positively charged hydrogen ions H+ and doubly negatively charged oxygen ions O²⁻. The positively charged hydrogen ions H+ take up electrons and are reduced to molecular hydrogen H₂, and the doubly negatively charged oxygen ions O²⁻ diffuse-driven by a concentration gradient and the electric field imposed in the electrolysis cells by way of the DC source 311—in the direction of the anodes 301. Having arrived at the anodes 301, there they release electrons and are oxidized to form molecular oxygen 02. The oxygen deposited at the anode can be purged from the system by the supply of air drawn from the surroundings and filtered, for example. Water vapor not consumed on the cathode side is purged from the cathode together with the generated hydrogen by the water vapor fed in and can be subjected to thermal and/or material recycling in a subsequent step. Instead of hydrogen as fuel gas in the reverse mode, water vapor is fed in as “fuel gas” in the normal mode. On the air side, air can continue to be brought in in order to set the oxygen concentration at the surface of the electrolyte 302. In the normal mode, the partial reactions illustrated in the table in FIG. 3b thus arise:

Anode: 2 O²⁻⇒O₂O+∝2 e⁻

Cathode: 2 H₂O+4e⁻⇒2 H₂+2 O²⁻

A speed of the electrolysis reaction—and thus the rate of electrolytic generation of hydrogen H₂—can be regulated or set by way of the AC/DC converter 3 of the supply circuit or unit 10, inter alia.

The signs of the voltages present at anode and cathode are reversed from FIG. 3a to FIG. 3b. In addition, however, that electrode which forms the anode in the reverse mode becomes the cathode in the normal mode on account of the reduction proceeding there in the normal mode. Conversely, that electrode which constitutes the cathode in the reverse mode becomes the anode in the normal mode on account of the oxidation proceeding in the normal mode. In sum, the signs of the DC voltages present at the respective electrodes remain unchanged during the change from the reverse mode to the normal mode. The DC disconnection circuit 5 of the supply circuit or unit 10 can be opened during the transition from the reverse mode to the normal mode. This is not absolutely necessary, however.

What is claimed is:

1. A method for a starting of an electrolysis system, comprising an electrolyzer and a supply circuit or unit operating as a rectifier, wherein the supply circuit or unit has an AC terminal connected to an AC grid, a DC terminal connected to the electrolyzer, and an AC/DC converter arranged between the AC terminal and the DC terminal, comprising:
charging an output capacitor, which is connected to a DC converter terminal of the AC/DC converter, by operating the electrolyzer in a reverse mode as a DC voltage source, while the AC/DC converter is in a state in which it is connected to the electrolyzer and disconnected from the AC grid,
connecting the AC/DC converter to the AC grid,
reversing an operation of the electrolyzer from the reverse mode to a normal mode as a DC load, wherein, during the reversing of the operation, a power flow between the AC grid and the electrolyzer is completely or at least largely suppressed, and
operating the electrolyzer in the normal mode as a DC load with electrical power which is drawn from the AC grid by way of the supply circuit or unit and which is rectified by way of the AC/DC converter.

2. The method as claimed in claim 1, wherein the output capacitor is charged to a DC voltage whose value corresponds to at least a rectified value of an AC voltage present at the AC terminal.

3. The method as claimed in claim 1, wherein before connecting the AC/DC converter to the AC grid, generating an AC voltage by the AC/DC converter and synchronizing the generated AC voltage with an AC voltage present at the AC terminal of the supply circuit or unit.

4. The method as claimed in claim 1, wherein for reversing the operation, disconnecting the AC/DC converter from the electrolyzer is effected, and reversing the operation of the electrolyzer from the reverse mode to the normal mode is effected while the electrolyzer is in a state in which it is disconnected from the AC/DC converter, and wherein the AC/DC converter is connected to the electrolyzer again after reversing the operation has been effected.

5. The method as claimed in claim 1, wherein the AC/DC converter is selectively connected to the electrolyzer via a low-impedance connection and a high-impedance connection, and wherein for reversing the operation, disconnecting the low-impedance connection of the AC/DC converter from the electrolyzer is effected, reversing the operation of the electrolyzer from the reverse mode to the normal mode is effected in a disconnected state of the low-impedance connection between the AC/DC converter and the electrolyzer, and wherein the AC/DC converter is connected to the electrolyzer with low impedance again after reversing the operation has been effected.

6. The method as claimed in claim 4, wherein disconnecting the AC/DC converter from the electrolyzer is effected only if the AC/DC converter is connected to the AC grid.

7. The method as claimed in claim 5, wherein disconnecting the low-impedance connection between the AC/DC converter and the electrolyzer is effected only if the AC/DC converter is connected to the AC grid.

8. The method as claimed in claim 1, wherein a terminal of the electrolyzer having a DC voltage>0V is connected to the output capacitor via a precharge resistor or via a DC/DC converter.

9. The method as claimed in claim 1, wherein the electrolyzer is connected to the output capacitor of the supply circuit or unit while a terminal of the electrolyzer is in a state in which it is at least largely free of voltage, and the electrolyzer is put into the reverse mode while in a state connected to the supply circuit or unit.

10. An electrolysis system having an electrolysis unit comprising an electrolyzer, and having a supply circuit or unit, which feeds the electrolyzer from an AC grid, wherein the supply circuit or unit comprises:
an AC terminal configured to connect to an AC grid,
a DC terminal configured to connect to the electrolyzer,
an AC/DC converter arranged between the AC terminal and the DC terminal,
an AC disconnection circuit configured to connect an AC converter terminal of the AC/DC converter to the AC terminal, and
a DC disconnection circuit configured to connect a DC converter terminal of the AC/DC converter to the DC terminal,
a control circuit configured to control the electrolysis system, wherein the electrolysis system is configured to carry out a method, comprising:
charging an output capacitor, which is connected to a DC converter terminal of the AC/DC converter, by operating the electrolyzer in a reverse mode as a DC voltage source, while the AC/DC converter is in a state in which it is connected to the electrolyzer and disconnected from the AC grid,
connecting the AC/DC converter to the AC grid,
reversing an operation of the electrolyzer from the reverse mode to a normal mode as a DC load, wherein, during the reversing of the operation, a power flow between the AC grid and the electrolyzer is completely or at least largely suppressed, and
operating the electrolyzer in the normal mode as a DC load with electrical power that is drawn from the AC grid by way of the supply circuit or unit and that is rectified by way of the AC/DC converter.

11. The electrolysis system as claimed in claim 10, wherein the supply circuit or unit is free of an AC-side precharge resistor.

12. The electrolysis system as claimed in claim 10, wherein the DC disconnection circuit of the supply circuit or unit includes a series circuit formed by a precharge resistor and a precharge switch, and a switch arranged in parallel with the series circuit, or in that the DC disconnection circuit includes a DC/DC converter.

13. The electrolysis system as claimed in claim 10, wherein the supply circuit or unit comprises voltage sensors configured to detect an AC voltage dropped across the AC disconnection circuit and/or a DC voltage dropped across the DC disconnection circuit.

14. The electrolysis system as claimed in claim 10, wherein the control circuit is embodied as a separate control circuit configured to control the supply circuit or unit and also the electrolysis unit, or wherein the control circuit is at least partly integrated into a controller of the supply circuit or unit and/or a controller of the electrolysis unit.

15. The electrolysis system as claimed in claim 10, wherein the AC/DC converter comprises a transistor-based bridge circuit.

16. The electrolysis system as claimed in claim 10, wherein the supply circuit or unit comprises a passive filter configured to filter clock-frequency interference currents.

17. The electrolysis system as claimed in claim 10, wherein the AC/DC converter is configured to facilitate a bidirectional power flow.

18. The electrolysis system as claimed in claim 10, wherein the electrolyzer comprises a solid oxide electrolyzer or a PEM electrolyzer and is configured to provide electrical energy from a chemical energy carrier in the reverse mode.
